(19) United States
(12) Patent Application Publication
(10) Pub. No.: US 2023/0406454 A1
(43) Pub. Date: Dec. 21, 2023

(54) Moveable Seat Assembly With Locking Mechanism

(71) Applicant: PB Holdco, LLC DBA Pursuit Boats, Ft. Pierce, FL (US)

(72) Inventors: Linwood Addison Fuller, IV, Vero Beach, FL (US); Christopher M. Gratz, Stuart, FL (US); Adrian William Abadie, Vero Beach, FL (US)

(73) Assignee: PB Holdco, LLC DBA Pursuit Boats, Ft. Pierce, FL (US)

(21) Appl. No.: 18/240,934

(22) Filed: Aug. 31, 2023

Related U.S. Application Data
(63) Continuation-in-part of application No. 17/658,128, filed on Apr. 6, 2022, now Pat. No. 11,772,748.
Application No. 17/658,128 is a continuation of application No. 16/860,820, filed on Apr. 28, 2020, now Pat. No. 11,319,027.
(60) Provisional application No. 62/841,572, filed on May 1, 2019.

(51) Int. Cl. B63B 19/18; B63B 3/48

(52) U.S. Cl. CPC B63B 19/18; B63B 3/48; E05Y 2900/514; B63B 2017/0054

(57) ABSTRACT

A moveable component assembly includes a seat assembly, a track system, and a locking mechanism that secures the seat assembly in position. The track system is coupled at least indirectly to the seat assembly and guides the seat assembly along a path between a first and second position. The seat assembly is secured in the second position when the seat assembly is disposed away from the deck's walking surface, thereby resulting in the components of the track system being frictionally coupled. A floor panel includes a locking mechanism and a series of alignment surfaces that guide the floor panel into position, which is secured by the locking mechanism.

### CROSS-REFERENCE TO RELATED APPLICATIONS

This U.S. patent application claims priority under 35 U.S.C. § 119(e) to U.S. Non-Provisional application Ser. No. 17/658,128 filed on Apr. 6, 2022, which claims priority to U.S. Non-Provisional application Ser. No. 16/860,820 filed on Apr. 28, 2020, now granted as U.S. Pat. No. 11,319,027 on May 3, 2022, which claims priority to U.S. Provisional Application No. 62/841,572 filed on May 1, 2019, the disclosure of which is considered part of the disclosure of this application and is hereby incorporated by reference in its entireties.

### TECHNICAL FIELD

The present disclosure generally relates to systems and methods for manipulating vehicle components and, more particularly, manipulation systems and methods for re-positioning components to maximize the efficient use of space on a deck or the like.

### BACKGROUND

This section provides background information related to the present disclosure and is not necessarily prior art.

By their nature, vehicles, such as boats, offer limited space for arranging components such as equipment, furniture (e.g., seats, containers, etc.), and the like. Accordingly, a robustly engineered packaging and arrangement of such components can allow for the efficient and functional use of the available space on the vehicle. While known systems for arranging such vehicle components have proven acceptable for their intended purpose, there remains a continuous need for improvement in the pertinent art.

### SUMMARY

This section provides a general summary of the disclosure and is not a comprehensive disclosure of its full scope or all of its features.

One aspect of the disclosure provides a system for manipulating one or more boat structures to efficiently use critical deck space when certain functions are required and to relinquish that space when those functions are no longer needed. Additionally, because of the tight quarters commonly found on boats, poorly located objects such as walls, equipment, furniture, etc., can pose inconveniences and, in some cases, hazards.

Another aspect of the disclosure provides a seat manipulating system largely located below the boat deck with minimum penetration above the boat deck, thereby eliminating all trip hazards.

Another aspect of the disclosure provides a component assembly. The component assembly may include a drive mechanism indirectly coupled to the component assembly. The associated drive mechanism may manipulate the component assembly along a path. A track/slide system may be coupled at least indirectly to the component assembly for guiding the movement of the component assembly along the path. A below-deck cavity structure supports the associated drive mechanism. The component assembly may be located substantially above a floor panel having an upper surface. The drive mechanism and the track/slide system may be located within the below deck cavity structure and below the upper surface.

Yet another aspect of the present disclosure provides a slide system. The slide system includes a component assembly, a track system, a floor panel, and a below-deck cavity. The track system is coupled at least indirectly to the component assembly for guiding movement of the component assembly along a path. The floor panel includes an upper surface. The below-deck cavity is disposed below the floor panel. The component assembly is located substantially above the floor panel. The track system is located below the deck cavity and the upper surface.

Implementations of this aspect of the disclosure may include one or more of the following optional features. In some implementations, the slide system includes a drive mechanism at least indirectly coupled to the component assembly. The component assembly may be manipulatable along the path by the drive mechanism. In some implementations, the slide system includes a motor operable to actuate the drive mechanism. In some implementations, the drive mechanism includes a cable coupled to the motor and the component assembly. The cable may be configured to move the component assembly relative to the floor panel.

In some implementations, the component system includes at least one of a seat or an entertainment system.

In some implementations, the track system includes a first portion and a second portion configured to translate relative to the first portion. The first portion may be fixed within the cavity. The second portion may be coupled to the component assembly for translation therewith.

In some implementations, the floor panel defines a slit. The slide system may also include a support structure coupled to the component assembly and the track system. The support structure may be at least partially disposed within the slit. The support structure may include a lateral section and an upper wall extending from the lateral section. At least a portion of the lateral section may be disposed below the upper surface. The upper wall may be disposed above the upper surface. The floor panel may be disposed between the upper wall and the cavity relative to a direction extending perpendicular to the path.

Another aspect of the disclosure provides a slide system. The slide system may include a deck, a floor panel, a track system, and a support structure. The deck may define a cavity and an opening in communication with the cavity. The floor panel may cover a portion of the opening. The deck and the floor panel may define a slit. The track system may be disposed within the cavity. The support structure may be coupled to the track system and include a portion translatably disposed within the slit. The track system may be configured to move the portion of the support structure within the slit.

This aspect may include one or more of the following optional features.

In some implementations, the slide system includes a component assembly coupled to the support structure. The component assembly may be located substantially above the floor panel. The track system may be located below the floor panel. The component assembly may include at least one of a seat or an entertainment system.

In some implementations, the slide system includes a drive mechanism at least indirectly coupled to the support structure. The support structure may be manipulatable along a path by the drive mechanism. In some implementations, the slide system includes a motor operable to actuate the drive mechanism. The drive mechanism may include a cable coupled to the motor and the support structure. The cable may be configured to move the support structure relative to the floor panel.

The track system may include a first portion and a second portion. The second portion may be configured to translate relative to the first portion. The first portion may be fixed within the cavity. The second portion may be coupled to the support structure for translation therewith.

In some implementations, the support structure includes a lateral section and an upper wall extending from the lateral section. At least a portion of the lateral section may be disposed below the floor panel. The upper wall may be disposed above the floor panel. The slit may extend in a travel direction. The floor panel may be disposed between the upper wall and the cavity relative to a direction extending perpendicular to the travel direction.

Yet another aspect of the disclosure provides a slide system. The slide system may include a component assembly, a track system, a floor panel, and a cavity. The track system may be coupled to the component assembly and define a path of movement of the component assembly. The floor panel may include an upper surface and be disposed between the component assembly and the track system. The cavity may be disposed below the floor panel. The component assembly may be disposed above the floor panel. The track system may be located within the cavity and below the upper surface.

This aspect may include one or more of the following optional features.

In some implementations, the floor panel defines a slit. The slide system may also include a support structure coupled to the component assembly and the track system and at least partially disposed within the slit.

In another aspect, the slide system includes a slide assembly. The slide assembly may include a component assembly moveable between a first and second positions. When in the second position, at least a portion of the cavity disposed within the deck is inaccessible. The component assembly has a first engagement member extending outwardly from a bottom surface of the seat assembly. In an embodiment, the first engagement member may be fixedly disposed on the bottom surface of the component assembly. In yet another embodiment, the first engagement member is an elongated member having a bottom surface that is generally planar. A second engagement member is disposed on a desk's walking surface, faces the bottom surface of the component assembly, and engages the first member. The second engagement member may be detachably coupled to the deck's walking surface. The second member has a tapered surface that increases in height in a direction from the first position to the second position. In an embodiment, the second member is a cuboidal member. The track system is coupled to the seat assembly and the desk and configured to guide the component assembly moment between the first and second positions.

In the first position, the first engagement member is spaced apart from the second engagement member. In the second position, the first engagement member is engaged with the second engagement member and raised relative to the first position to secure the component assembly in the second position. In an embodiment, the track system includes a first portion coupled to one of the deck and the component assembly and a second portion coupled to the other of the deck and the component assembly. The first portion may be one of a rail and a track system, and the second portion may be the other of the rail and the track system. In the second position, the second portion of the track system is frictionally coupled with the first portion, thereby securing the component assembly in the second position.

In an implementation, the first engagement member is a pair of first engagement members disposed on opposite sides of the component assembly and spaced apart from one another by a first predetermined distance. The second engagement member is a pair of second engagement members spaced apart from each other at a second predetermined distance. The first predetermined distance and the second predetermined distance are substantially equal.

In yet another implementation, a compartment of the deck includes the cavity disposed beneath an opening of the deck. A compartment is disposed within the cavity and includes a top wall having a first beveled edge opposite a second beveled edge. The first beveled edge and the second beveled edge disposed on a periphery of the top wall. A floor panel including a pair of first alignment members is recessed from a peripheral edge of the floor panel. Each of the pair of first alignment members is configured to mate with a corresponding one of the first beveled edge and the second beveled edge so as to center the floor panel with respect to the opening of the cavity. Each of the pair of first alignment members has an outer wall spaced apart from an inner wall, the inner wall corresponding in shape to a respective first beveled edge and second beveled edge. In an embodiment, the inner wall is planar and angled. Moreover, the inner walls are spaced apart from each other at a first distance that is substantially equal to the length of the top wall. Each of the pair of alignment members includes a first portion spaced apart from a second portion, wherein the first portion is coaxial with the second portion.

In another implementation, the slide assembly includes the component assembly, the deck, and a locking mechanism. The component assembly is translatable between a first position and a second position. The deck closes the cavity and has a first alignment surface configured to engage a second alignment surface of a floor panel residing at least partially within the cavity of the deck. The floor panel is inaccessible when in the first position. The floor panel is translatable between an open configuration and a closed configuration, such that the cavity is inaccessible in the closed configuration. The locking mechanism includes a first engagement portion coupled to the deck and a second engagement portion coupled to the floor panel. The first engagement portion is configured to mechanically couple the second engagement portion, thereby securing the floor panel in the closed position. In an embodiment, the locking mechanism is controlled by a switch mounted in an area away from the locking mechanism. In yet another embodiment, the floor panel includes a top surface, a bottom surface, and a body extending between the top and bottom surfaces. The first engagement portion is coupled to the bottom surface of the floor panel, such that the first engagement portion resides below a walking surface of the deck when the hatch is in the closed position. The first and second alignment surfaces reside within parallel planes.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations and are not intended to limit the scope of the present disclosure.

FIG. 1 is a plan view of a vehicle, including a slide system in accordance with the principles of the present disclosure.

FIG. 2 is a schematic plan view of the slide system of FIG. 1.

FIG. 3 is a schematic elevational view of a side of the slide system of FIG. 1.

FIG. 4 is a schematic elevational view of another side of the slide system of FIG. 1.

FIG. 5A is a cross-sectional perspective view of a portion of the slide system of FIG. 1.

FIG. 5B is an enlargement of portion 5B of FIG. 5A.

FIG. 5C is a cross-sectional elevation view of the portion 5B of FIG. 5A.

FIG. 6 is another cross-sectional elevation view of the portion 5B of FIG. 5A.

FIG. 7A is a cross-sectional view taken along line B-B of FIG. 5A.

FIG. 7B is a perspective view of the locking mechanism disposed within the cavity.

FIG. 8A is a cross-sectional view taken along line A-A of FIG. 1, with the component assembly in the first position.

FIG. 8B is a cross-sectional view taken along line A-A of FIG. 1, with the component assembly in the second position.

FIG. 9A is a perspective view of the first and second engagement members shown as ghost lines, with the floor panel removed from the compartment.

FIG. 9B is a perspective view of the first engagement members and the second engagements shown as ghost lines, with the floor panel positioned over the compartment.

FIG. 10A is a cross-sectional view of a portion of the vessel of FIG. 1, showing the component assembly in the first position and the first and second engagement members spaced apart from one another.

FIG. 10B is a cross-sectional view of a portion of the vessel of FIG. 1, showing the component assembly in the second position and the first and second engagement members engaged with one another.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough and will fully convey the scope of the disclosure to those of ordinary skill in the art. Specific details are set forth, such as examples of specific components, devices, and methods, to provide a thorough understanding of the configurations of the present disclosure. It will be apparent to those of ordinary skill in the art that specific details need not be employed, that example configurations may be embodied in many different forms, and that the specific details and the example configurations should not be construed to limit the scope of the disclosure.

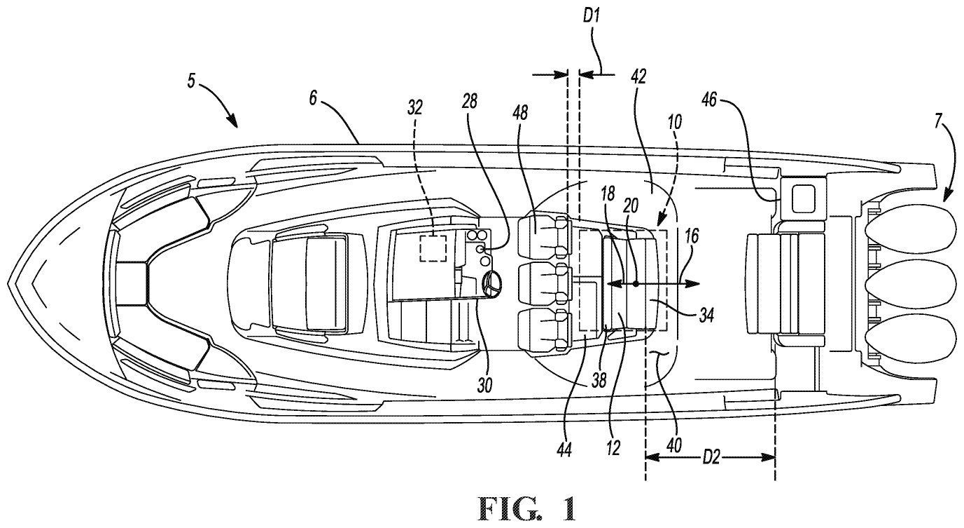

Referring to FIG. 1, a vehicle 5, including a body 6, an engine 7, and a slide system 10 is shown. While vehicle 5 is shown and described herein as being a motorized watercraft (e.g., a boat), any vehicle 5 such as an automobile, a bus, or other suitable forms of transportation within the scope of the present disclosure.

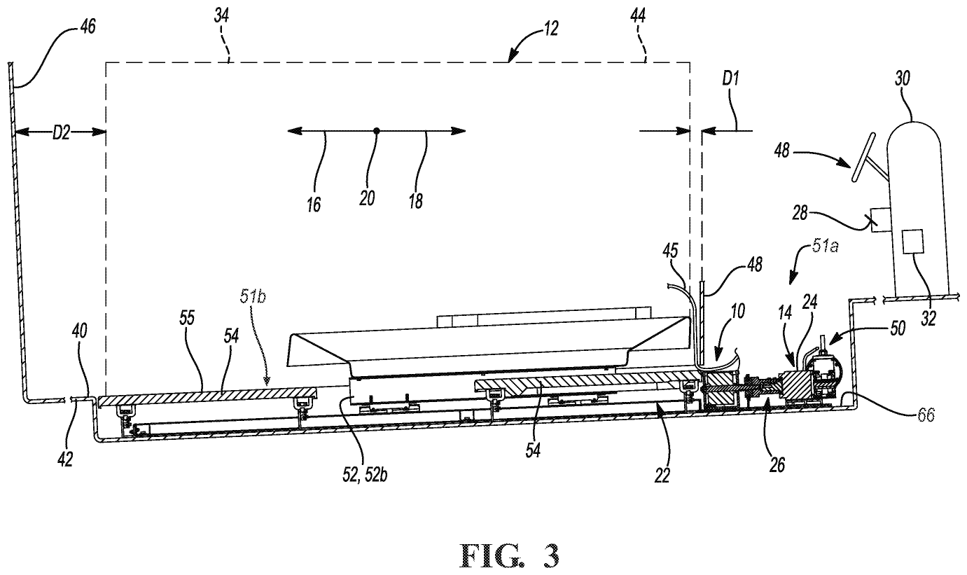

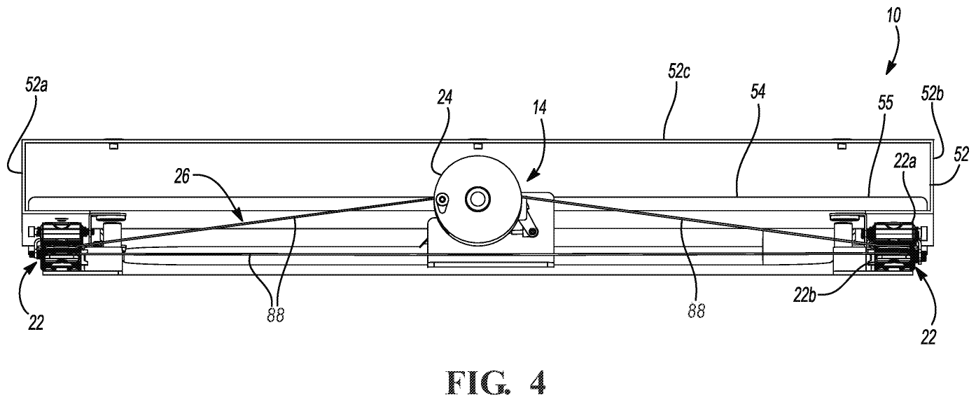

The slide system 10 includes component assembly 12 and an associated drive mechanism 14. As will be explained in more detail below, the component assembly 12 can be manipulated along a reverse travel direction 16 and a forward travel direction 18, collectively defining a path 20. For example, as illustrated in FIGS. 3-6, the component assembly 12 may ride (e.g., translate) upon a track system 22 between a first position 13 and a second position 15. In particular, the component assembly 12 may be manipulated along the reverse direction 16 and the forward direction 18 by way of a drive motor 24 and associated drive linkage 26. With reference to FIGS. 1 and 3, the manipulation of the drive motor 24 can be accomplished by toggling a control switch 28 in a fore or aft position, which may be respectively associated with moving the component assembly 12 in the reverse 16 or forward 18 direction. The control switch 28 can be mounted in any convenient location, including on a control console 30 of vehicle 5. The control switch 28 interfaces with a motor controller 32, which, in turn, is connected electrically to, and communicates with, the drive motor 24. Methods and systems for using a fore/aft electric switch to control the reverse/forward rotational direction of a motor are well known to those skilled in the art, the details of which are not discussed any further herein.

The component assembly 12 can be comprised of any number of components, including a first seat 34 and a second seat 36 (not shown). In this arrangement, the second seat may optionally be attached back-to-back with the first seat 34, such that the second seat is completely supported (e.g., cantilevered) from a backrest portion 38 of the first seat 34. By arranging the first seat 34 and the second seat in this way, the second seat 36 may be free-floating and not contact an outer walking surface 40 of a deck 42 of the vehicle 5.

With reference to FIGS. 1 and 3, in some implementations, the component system assembly 12 includes other components. For example, the component assembly 12 may include an entertainment system structure 44. In this regard, the first seat 34 may support the entertainment system structure 44. Specifically, the first seat 34 can support (e.g., cantilevered), the entertainment system structure 44 for housing a sink, a grill (sink and grill not shown), or any other system used on vehicle 5. Depending on the type of system housed in the entertainment system structure 44, various services may be necessary to run to and from the entertainment system structure 44. In this regard, as illustrated in FIG. 3, the vehicle 5 may include one or more service conduits 45 (e.g., a gas line for fueling a grill, hot and cold water service conduits for a sink, a wastewater drain system conduit for the sink, electrical service conduits for powering an electric grill, garbage disposal, or any other electrical device located within the entertainment system structure 44).

The component assembly 12 is manipulatable along the path 20. For example, as illustrated in FIGS. 1 and 3, the component assembly 12 may be located between a wall 46 and one or more seats 48 or other structures (e.g., a steering wheel). When there is no need to access the entertainment system structure 44, the component assembly 12 can be manipulated such that a space or distance D1 measured along (e.g., parallel to) the path 20 between the component assembly 12 and the one or more other seats 48 can be minimized. This allows a space or distance D2 measured along (e.g., parallel to) the path 20 between the component assembly 12 and the wall 46 to be maximized for use as an aisle way, for access to the motor or other area of the vehicle 5, for accessing other controls, etc. On the other hand, when a user desires to access the component assembly 12 (e.g., the entertainment system structure 44), the user can manipulate the control switch 28, such that the component assembly 12 is manipulated in the reverse direction 16, thereby minimizing the distance D2 and maximizing the distance D1.

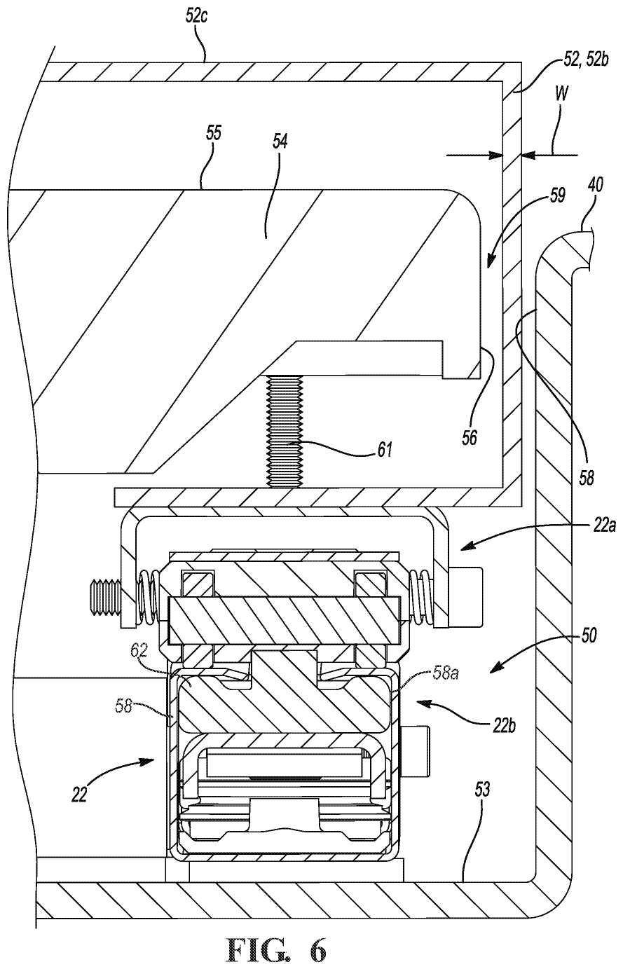

Now referring to FIGS. 3 and 5A-6, optionally, the drive mechanism 14 is located in a cavity 50, which is located below the walking surface 40 of the deck 42. In this regard, the deck 42 may define a first opening 51a in the walking surface 40. The first opening 51a may be in fluid communication with the cavity 50. Optionally, the only portion of the drive mechanism 14 that extends above the walking surface 40 is a support structure 52 for supporting the component assembly 12 (e.g., the first seat 34 and/or the entertainment system structure 44). In some implementations, the support structure 52 is a bent plate. In this regard, the support structure 52 may be referred to as bent plate 52. In some implementations, the deck 42 includes a narrow slit 56 disposed between a floor panel 54 (e.g., a peripheral edge 54a of the floor panel 54) and the deck 42 (e.g., an edge 42a of the deck 42). In this regard, the slit 56 may be the only opening between the peripheral edge 54a of the floor panel 54 and the edge 42a of the deck 42. The narrow slit 56 does not have to be any wider than necessary to allow the width W (see FIG. 6) of the bent plate 52 to pass through from cavity 50.

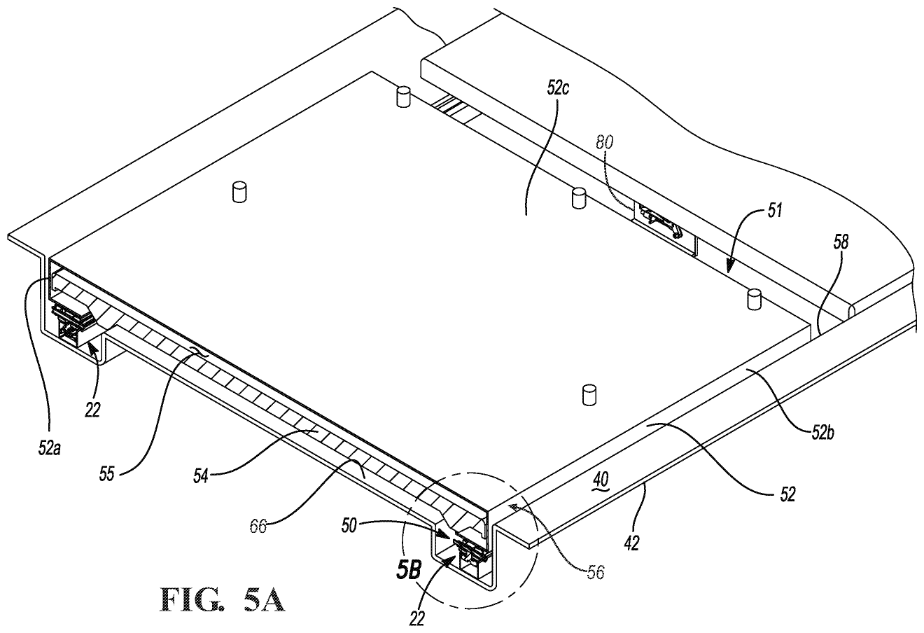

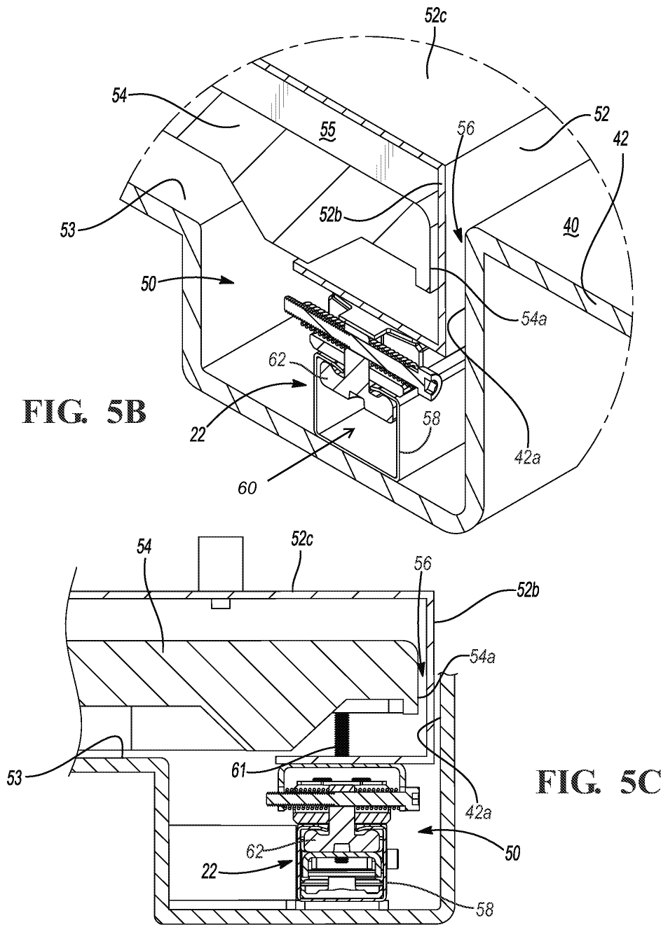

As illustrated in FIG. 5A-6, the bent plate 52 can be comprised of right and left lateral sections 52a, 52b, wherein each right and left lateral section 52a, 52b is supported by one or more of the track systems 22. The track systems 22 may include a body 58 having an interior surface 58a that defines a channel 60 for receiving a guide member 62. The guide member 62 may reside at least partially within channel 60 and is configured to guide the bent plate 52 along path 20. Moreover, one or more first fasteners 64 (e.g., bolts) may couple the bent plate 52 to a first portion 22a of the track system 22. The right lateral section 52a may be coupled to the left lateral section 52b at an upper wall or section 52c of the bent plate 52 such that the bent plate 52 defines a “C” shaped construct. In this regard, the floor panel 54 may be at least partially disposed within the bent plate 52, such that the floor panel 54 is disposed between the upper wall 52c and the right and left lateral sections 52a, 52b, respectively, of the bent plate 52 in a direction extending substantially perpendicular to the path 20. In some implementations, the cavity 50 is defined in part by a lower wall 66 extending substantially parallel to the deck 42, and the floor panel 54 is disposed between the lower wall 66 of the deck 42 and the upper wall 52c of the bent plate 52 in the direction extending substantially perpendicular to the path 20.

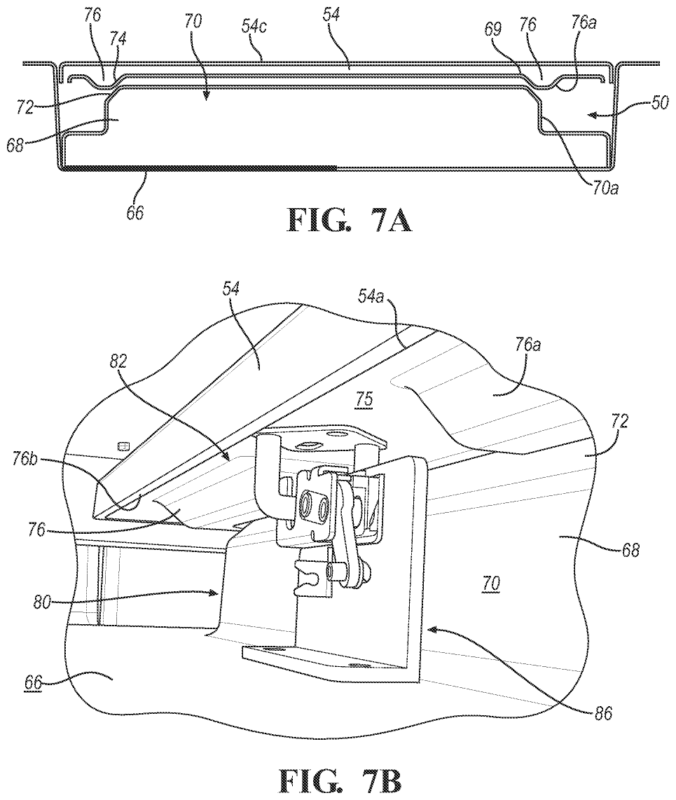

The floor panel 54 covers the below deck cavity 50 and closes a second opening 51b of the below deck cavity 50. As shown in FIGS. 7A and 7B, a compartment 68 may be disposed within the below deck cavity 50. The compartment 68 may include an exterior wall 70, having a peripheral side wall 70a defining the sides of the compartment 70 and a top wall 70b closing the compartment 70. The peripheral side wall 70a and the top wall 70b may be integrally formed to each other. The peripheral side wall 70a includes a first beveled edge 72 opposite a second beveled edge 74, each disposed at least partially about the top portion of the periphery of the side wall 70a. The compartment 68 is illustrated as a panel of material enclosing a space. The compartment 68 may be integrally formed to the deck 42 or may be made as a separate piece and attached to the deck 42 using known attachment means such as a bolt and nut, welding, adhesives, or the like.

The floor panel 54 includes a pair of alignment members 76 (e.g., first alignment member 76a and second alignment member 76b) disposed inwardly from the peripheral edge 54a of the floor panel 54. The first alignment member 76a is spaced apart from the second alignment member 76b and may extend along an axis defining a width of the vehicle 5. Each of the pair of alignment members 76 include a second beveled edge 72b that is configured to mate with a corresponding first beveled edge 72a of the compartment 68. The mating of the first beveled edge 72a and second beveled edge 72b centers the floor panel 54 with respect to the second opening 51b of the below deck cavity 50. Moreover, the first alignment members 76 has an outer wall 76a spaced apart from and facing the peripheral edge 54a of the floor panel 54. The outer wall 76a is opposite of an inner wall 76b that faces the interior of the floor panel 54 so as to face each other. The outer wall 76a and the inner wall 76b are angled so as to form a generally bowl-shaped cross-section. The inner wall 76b corresponds in shape to the corresponding first and second beveled edges 72, 74. In one aspect, the first beveled edge 72 and the second beveled edge 74 are angled so as to be complementary with the angle of the corresponding inner wall 76b of the floor panel 54. As such, the inner walls 76b slide onto the corresponding first beveled edge 72 and second beveled edge 74 so as to automatically seat and position the floor panel 54 onto the compartment in a manner where the floor panel 54 is generally centered with respect to the compartment 70, that is the top wall 70b is disposed between the respective inner wall 76b of alignment members 76 of the floor panel 54.

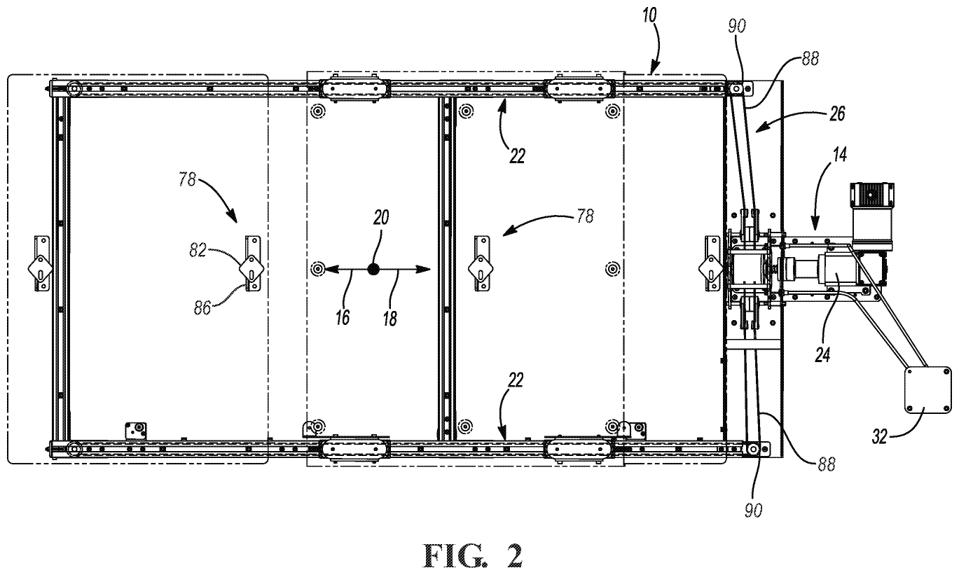

As illustrated in FIGS. 2 and 7B, in some implementations, the floor panel 54 is coupled to the lower wall 66 of the deck 42 by one or more second fasteners 78 (e.g., a U-bolt or magnet). Optionally, the floor panel 54 can be easily removed from the compartment 68 by removing the one or more second fasteners 78 for servicing the below deck drive mechanism 14 or accessing items stored within the compartment 68. In an embodiment, second fasteners 78 may be a locking mechanism 80 having a first engagement portion 82 coupled to a bottom surface 54b of the floor panel 54 and disposed between a gap 54 formed the pair of alignment members 76. In such an aspect, the first alignment member 76a and the second alignment member 76b are coaxial with each other and may have the same dimensions and/or shape. The first engagement portion 82 is disposed within the gap 84.

A second engagement portion 86 is coupled to the deck 42 and may be positioned adjacent to an exterior wall 70 of the compartment 68. Upon the floor panel 54 being positioned over compartment 68, the first engagement portion 82 and the second engagement portion 86 are configured to engage one another mechanically, thereby securing (i.e., locking) floor panel 54 over cavity 50. In an embodiment, the locking mechanism 80 may be remotely controlled via a second control switch (not shown) mounted in any convenient location in the vehicle 5. The second control switch is in electrical communication with the locking mechanism 80 and controls the coupling and decoupling (e.g., locking and unlocking) of the first engagement portion 82 and the second engagement portion 86. Methods and systems for using an electronic switch to control the locking and unlocking of a locking mechanism are well known to those skilled in the art, the details of which are not discussed any further herein.

Optionally, the material thicknesses and geometries of the floor panel 54 are designed and/or sized such that the walking surface 40 is generally positioned at the same horizontal level as (e.g., coplanar with) an upper surface 54c of the floor panel 54. By arranging the floor panel 54, the walking surface 40, and the drive mechanism 14 in this manner, the floor panel 54, the walking surface 40, and the components (e.g., the drive motor 24, the drive linkage 26, and/or any other components of the below deck drive mechanism 14) do not present any trip hazards for the user.

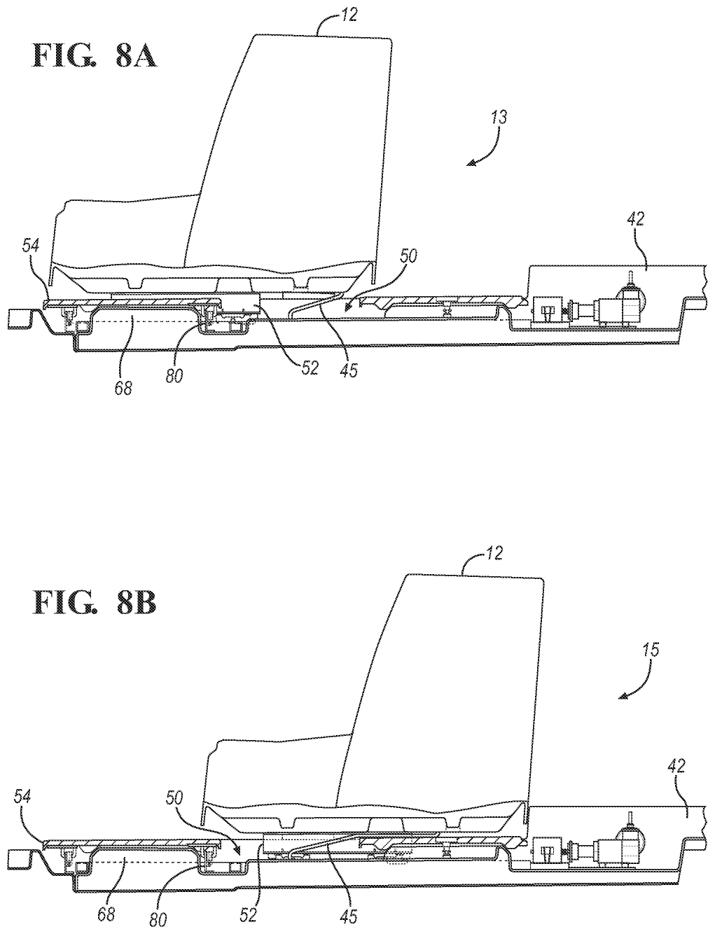

With reference to FIGS. 2, 4, 8A, and 8B, the drive mechanism 14 and/or the associated drive linkage 26 may further include one or more cables 88 and one or more pulleys 90 coupled to the drive motor 24 and the track system 22. In particular, a first end or portion of the cable(s) 88 may be coupled to the drive motor 24, while a second end or portion of the cable(s) 88 may be coupled to the first portion 22a of the track system 22 that is translatably coupled to a second portion 22b of the track system 22. In this regard, the first portion 22a of the track system 22 may be coupled to the component assembly 12, while the second portion 22b of the track system 22 may be coupled to the deck 42 or lower wall 66 or other portion of the vehicle 5 disposed within the cavity 50 such that actuation of the drive motor 24 increases or decreases the length of the cable(s) 88 and/or causes the cable(s) 88 to translate along the pulley(s) 90. In this regard, as the cable(s) 88 translates along the pulley(s) 90, it may apply a force on the first portion of the track system 22 and cause the first portion of the track system 22 to translate relative to the second portion of the track system 22. Translation of the first portion of the track system 22 relative to the second portion of the track system 22 can cause the support structure 52 to translate within the slit 56, and relative to the floor panel 54 and/or the deck 42, and cause the component assembly 12 to translate coaxially with respect to the length of the vehicle 5 along the path 20 in the forward direction 18 and/or the reverse direction 16 between the first position 13 and the second position 15. When in the first position 13, the component assembly 12 is positioned in an aft position, and in the second position 15, the component assembly 12 is positioned in a forward position. As stated above, the drive mechanism 14 is configured to manipulate the component assembly 12 along the path by the drive mechanism 14. Accordingly, it should be appreciated that the drive mechanism 14 disclosed herein is illustrative and does not limit the scope of the appended claims. Any drive mechanism 14 currently known or later developed may be modified for use herein, illustratively including a hydraulic ram.

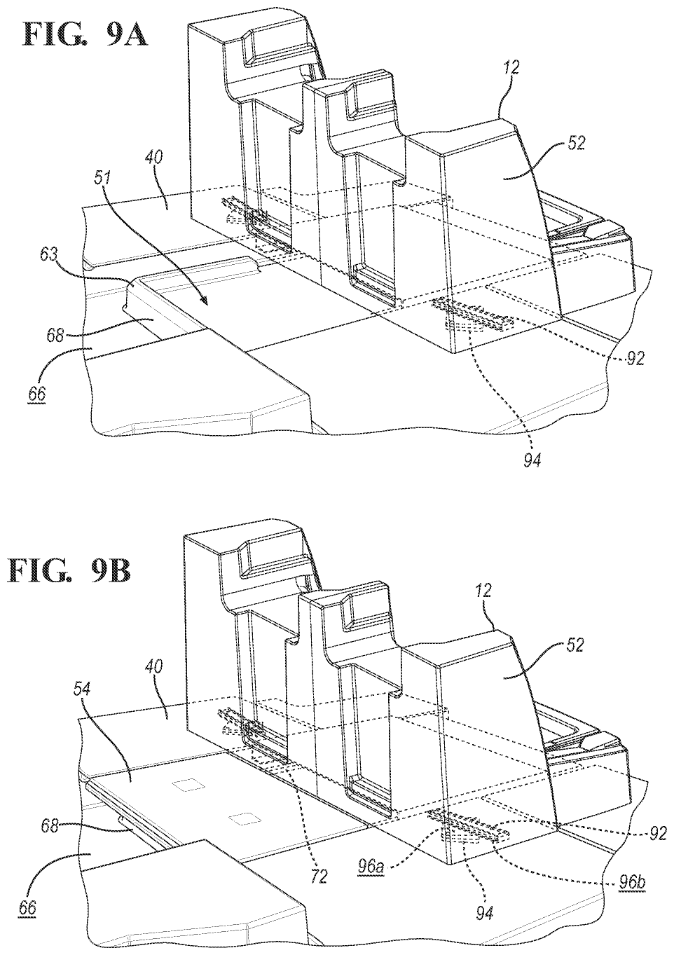

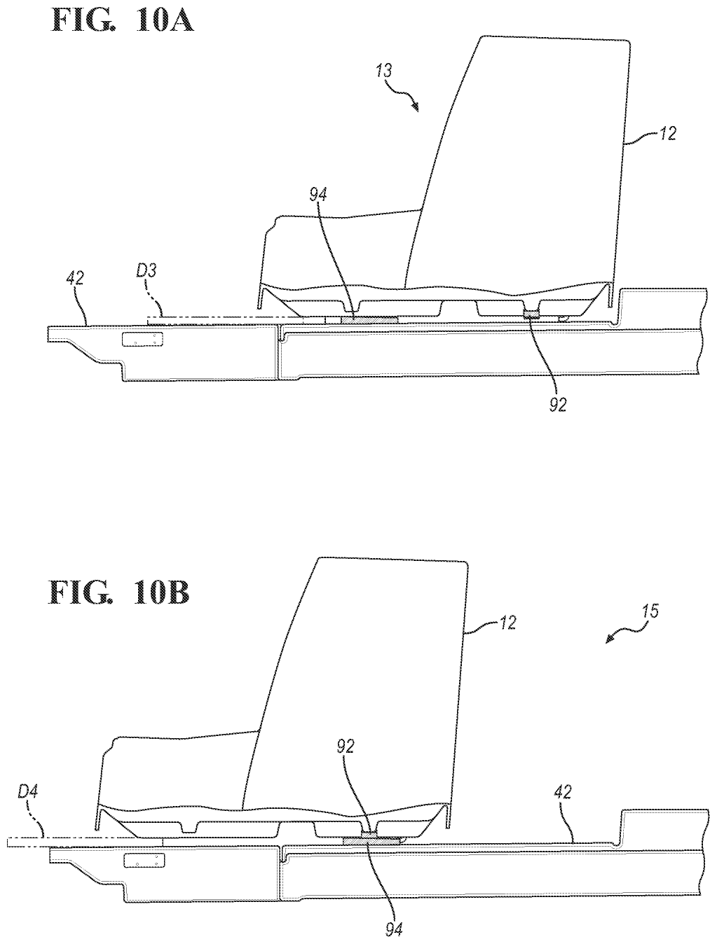

As shown in FIGS. 9A-10B, the component assembly 12 includes one or more first engagement members 92 disposed on or formed integrally with a bottom surface 12a of the component assembly 12. Each of the first engagement members 92 is configured to engage one or more second engagement members 94 disposed on or formed integrally with the walking surface 40. In an embodiment, the second engagement member 94 is removably coupled with the walking surface 40 so that the second engagement member 94 can be removed to prevent tripping when not being used to secure the support structure 52 in the second position 15. When in the first position 13, the first engagement members 92 are spaced apart from the second engagement members 94 in both a vertical and horizontal direction, as described in greater detail below. In the second position 15, the first engagement member 92 is engaged with the second engagement member 92, so as to secure the support structure 52 in the second position 15.

The first and/or second engagement members 92, 94 facilitate or encourage the raising or lowering of the support structure 52 when the support structure 52 is translated between the first position 13 and the second position 15. In particular, as support structure 52 moves toward the second position 15, the tapered surfaces 96a and 96b contact one another and urge the support structure 52 upwards and away from the walking surface 40. The displacement of the support structure 52 upwards and away from the walking surface 40 causes the guide member 57 to frictionally couple with the interior surface 66a, thereby securing the support structure 52 in the second position.

In an embodiment, including a pair of first engagement members 92, the pair of first engagement members 92 are spaced apart from each other along a width of the vehicle 5 so as to be on opposite ends of the component assembly 12. The second engagement members 94 are a pair of second engagement members 94 and spaced apart from each other along a width of the vehicle 5 at a distance the same as the distance between the pair of first engagement members 92 so as to be positioned in the same or substantially the same configuration and spacing as the first engagement members 92. Optionally, when the first engagement member 92 is a pair of first engagement members 92a, 92b, each of the pair of first engagement members 92a, 92b may be disposed on opposite sides of the support structure 52 and spaced apart from one another by a first predetermined distance. In such embodiments, when the second engagement member 94 is a pair of second engagement members 94a, 94b, each pair of the second engagement members 94a, 94b is spaced apart from one another by a second predetermined. The first and second predetermined distances are substantially equal to ensure the proper alignment of the first and second pairs of engagement members 92, 94.

As shown in FIGS. 9A and 9B, the first engagement member 92 is an elongated member having a tapered surface 96a that is generally planar. Moreover, the second engagement member 94 may be a cuboidal member with a tapered surface 96b increasing in height from the first position 13 to the second position 15. It is also contemplated that the second engagement member 94 may be any geometric shape to increase the height of the support structure 52 when the second engagement member 94 interacts with the first engagement member 92.

As depicted in FIGS. 5A-6 and 10A-10B, when the support structure 52 is in the first position, the bottom surface 12a of the component assembly 12 is spaced apart from the support structure at a distance D3, as shown in FIG. 10A. As the component assembly 12 is translated along path 20 from the first position 13 to the second position 15, the first engagement member 92 are slid into contact with the second engagement member 94, and the guide member 62 gradually engages interior surface 58a of body 58 as the support structure 52 is raised by the interaction of a first engagement member 92 and a second engagement member 94, such that distance D3 increases to distance D4 as shown in FIG. 10B. The engagement of the guide member 62 with the interior surface 58a results in the guide member 62 being frictionally coupled with the interior surface 58a of the body 58, thereby securing the support structure 52 in the second position 15. Translation of the support structure 52 in the reverse direction and toward the first position 15 results in the uncoupling of the guide member 62 from the interior surface 58a, as the support structure 52 is gradually lowered and translated in the reverse direction 16 and toward the first position 13, thereby decreasing distance D4 to D3, loosening the frictional engagement between the guide member 62 and the interior surface 58a of the body 58. It should be appreciated that as there are a pair of first engagement members 92 and a pair of second engagement member 94, the sides of the component assembly 12 are raised in a consistent manner, thus stabilizing the component assembly 12 along its side by virtue of the friction engagement along both tracks of the track system 22 so as to prevent the component assembly 12 from teetering about its side.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having” are inclusive and therefore specify the presence of features, steps, operations, elements, and/or components but do not preclude the presence or addition of one or more other features, steps, operations, elements, components, and/or groups thereof. The method steps, processes, and operations described herein are not to be construed as necessarily requiring their performance in the particular order discussed or illustrated unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc., may be used herein to describe various elements, components, regions, layers and/or sections. These elements, components, regions, layers and/or sections should not be limited by these terms. These terms may be only used to distinguish one element, component, region, layer, or section from another region, layer, or section. Terms such as “first,” “second,” and other numerical terms do not imply a sequence or order unless clearly indicated by the context. Thus, a first element, component, region, layer, or section discussed below could be termed a second element, component, region, layer, or section without departing from the teachings of the example configurations.

The foregoing description has been provided for purposes of illustration and description. It is not intended to be exhaustive or to limit the disclosure. Individual elements or features of a particular configuration are generally not limited to that particular configuration but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A slide assembly mounted to a deck of a vessel, the slide assembly comprising:
a seat assembly moveable between a first position and a second position, the seat assembly including a first engagement member extending outwardly from a bottom surface of the seat assembly;
a second engagement member disposed on a walking surface of the deck, the walking surface of the deck facing the bottom surface of the seat assembly, the second engagement member having a tapered surface so as to increase in height, the second member configured to operably engage the first member; and
a track system coupled to the seat assembly and the deck, the track system configured for guiding a movement of the seat assembly between the first position and the second position, wherein when in the first position, the first engagement member is spaced apart from the second engagement member, and when in the second position the first engagement member is engaged with the second engagement member and raised relative to the first position so as to secure the seat assembly in the second position.

2. The slide assembly of claim 1, wherein the track system further includes a first portion and a second portion, the first portion being coupled to one of the deck and the seat assembly, and the second portion being coupled to the other of the deck and the seat assembly.

3. The slide assembly of claim 2, wherein the first portion is one of a rail and a track system and the second portion being the other of the rail and the track system.

4. The slide assembly of claim 2, wherein when in the second position the second portion of the track system is frictionally coupled with the first portion of the track system, such that the seat assembly is secured in the second position.

5. The slide assembly of claim 1, wherein the second engagement member is detachably coupled to the walking surface of the deck.

6. The slide assembly of claim 5, wherein the first engagement member is a pair of first engagement members, each of the pair of first engagement members disposed on opposite sides of the seat assembly and spaced apart from each other by a first predetermined distance; and
wherein the second engagement member is a pair of second engagement members spaced apart from each other at a second predetermined distance;
wherein the first predefined distance is substantially equal to the second predefined distance.

7. The slide assembly of claim 1, further comprising a cavity disposed within a least a portion of the deck, the cavity inaccessible when the seat assembly is in the second position.

8. The slide assembly of claim 1, wherein the first engagement member is fixedly disposed on the bottom surface of the seat assembly.

9. The slide assembly of claim 1, wherein the first engagement member is an elongated member having a bottom surface, the bottom surface being generally planar.

10. The slide assembly of claim 1, wherein the second engagement member is a cuboidal member having a tapered surface increasing the height in a direction from the first position to the second position.

11. A compartment of a deck of a vessel, the compartment comprising:
a cavity disposed beneath an opening of the deck;
a compartment disposed within the cavity, the compartment including a top wall having a first beveled edge opposite of a second beveled edge, the first beveled edge and the second beveled edge disposed on a periphery of the top wall;
a floor panel including a pair of first alignment members recessed from a peripheral edge of the floor panel, each of the pair of first alignment members configured to mate with a corresponding one of the first beveled edge and the second beveled edge so as to center the floor panel with respect to the opening of the cavity.

12. The compartment of claim 11, wherein each of the pair of first alignment members has an outer wall spaced apart from an inner wall, the inner wall corresponding in shape to a respective first beveled edge and second beveled edge.

13. The compartment of claim 11, wherein the inner wall is planar and angled.

14. The compartment of claim 11, wherein the inner walls are spaced apart from each other a first distance, the first distance substantially equal to a length of the top wall.

15. The compartment of claim 11, wherein each of the pair of first alignment members includes a first portion and a second portion, the first portion spaced apart from the second portion.

16. The compartment of claim 15, wherein the first portion is coaxial with the second portion.

17. A slide assembly comprising:
a seat assembly translatable between a first position and a second position;
a deck defining a cavity therein, the deck having a first alignment surface configured to engage a second alignment surface of a floor panel, the floor panel residing at least partially within the cavity of the deck and inaccessible when in the first position;
the floor panel translatable between an open configuration and a closed configuration, wherein the cavity is assessable in the open configuration and inaccessible in the closed configuration;
a locking mechanism having a first engagement portion coupled to the deck and the second engagement portion coupled to the floor panel, wherein the first engagement portion is configured to mechanically couple the second engagement portion, thereby securing the floor panel in the closed position.

18. The slide assembly of claim 17, wherein the locking mechanism is operated by a control switch mounted on a control console.

19. The slide assembly of claim 17, wherein the floor panel further comprises:
a top surface, a bottom surface, and a body extending between the top surface and the bottom surface,
wherein the first engagement portion is coupled to the bottom surface of the floor panel, such that the first engagement portion resides below a walking surface of the deck when the floor panel is in the closed position.

20. The slide assembly of claim 17, wherein the first alignment surface resides within a first plane and the second alignment surface resides within a second parallel plane.
